(19) United States
(12) Patent Application Publication
(10) Pub. No.: US 2020/0183390 A1
(43) Pub. Date: Jun. 11, 2020

(54) REPLENISHMENT METHOD, APPARATUS AND STORAGE MEDIUM FOR SELF-DRIVING VENDING MACHINE

(71) Applicant: BEIJING BAIDU NETCOM SCIENCE AND TECHNOLOGY CO., LTD., Beijing (CN)

(72) Inventors: Ning YU, Beijing (CN); Zhijie WANG, Beijing (CN)

(73) Assignee: BEIJING BAIDU NETCOM SCIENCE AND TECHNOLOGY CO., LTD., Beijing (CN)

(21) Appl. No.: 16/653,050

(22) Filed: Oct. 15, 2019

(30) Foreign Application Priority Data
Dec. 10, 2018 (CN) 2018115052399

(51) Int. Cl. G05D 1/00; G06Q 20/18; G07F 11/00

(52) U.S. Cl. CPC G05D 1/0088; G07F 11/002; G06Q 20/18

(57) ABSTRACT

A replenishment method, apparatus and storage medium of a self-driving vending machine are proposed. The replenishment method include: obtaining information about remaining goods by a self-driving system in the self-driving vending machine; controlling the self-driving vending machine to drive automatically to a replenishment station for replenishment when determining, according to the information about remaining goods, that replenishment needs to be performed. The technical solution of the present disclosure may be applied to implement timely replenishment for the self-driving vending machine and ensure normal work of the self-driving vending machine.

### CROSS REFERENCE TO RELATED APPLICATION

This application claims priority to Chinese Patent Application No. 201811505239.9, filed on Dec. 10, 2018, with the title of “Replenishment method, apparatus and storage medium for self-driving vending machine,” which is incorporated herein by reference in its entirety.

### TECHNICAL FIELD

The present disclosure relates to computer application technologies, and particularly to a replenishment method, apparatus and storage medium for a self-driving vending machine.

### BACKGROUND

A self-driving vending machine implements a function of a vending machine on a self-driving vehicle, or integrating a conventional vending machine on a self-driving vehicle.

A self-driving vending machine may carry a limited number of goods at one time. If the business is hot during the sale process, the goods for sales will soon be snapped up. If the vehicle waits for the relevant personnel to actively discover the goods are out of stock and arrange replenishment, timeliness is difficult to guarantee, thus affecting the normal work of self-driving vending machine.

### SUMMARY

In view of the above, the present disclosure provides a replenishment method, apparatus and storage medium of a self-driving vending machine.

Specific technical solutions are as follows:

According to an embodiment, a replenishment method for a self-driving vending machine is proposed, the replenishment method includes:

obtaining information about remaining goods by a self-driving system in the self-driving vending machine;

controlling the self-driving vending machine to drive automatically to a replenishment station for replenishment when determining, according to the information about remaining goods, that replenishment needs to be performed.

According to an embodiment of the present disclosure, the obtaining information about remaining goods may include: obtaining a remaining quantity of goods; and

the controlling the self-driving vending machine to drive automatically to a replenishment station for replenishment when determining, according to the information about remaining goods, that replenishment needs to be performed may include:

determining that replenishment needs to be performed when the remaining quantity of goods is lower than a preset threshold and controlling the self-driving vending machine to drive automatically to the replenishment station for replenishment.

According to an embodiment of the present disclosure, the obtaining the remaining quantity of goods may include:

obtaining the remaining quantity of goods reported by a vending system in the self-driving vending machine periodically; or

obtaining the remaining quantity of goods reported by the vending system when the remaining quantity of goods is changed; or

obtaining the remaining quantity of goods reported by the vending system when the remaining quantity of goods is lower than the threshold.

According to an embodiment of the present disclosure, the determining that replenishment needs to be performed when the remaining quantity of goods is lower than a threshold may include:

if obtaining the remaining quantity of goods reported by the vending system periodically, or obtaining the remaining quantity of goods reported by the vending system when the remaining quantity of goods is changed, comparing the remaining quantity of goods obtained each time with the threshold, and determining that replenishment needs to be performed when the remaining quantity of goods is lower than the threshold;

if obtaining the remaining quantity of goods reported by the vending system when the remaining quantity of goods is lower than the threshold, determining that replenishment needs to be performed after obtaining the remaining quantity of goods.

According to an embodiment of the present disclosure, before controlling the self-driving vending machine to drive automatically to the replenishment station for replenishment, the method may further include:

determining the replenishment station according to a location of the self-driving vending machine; or

reporting the location of the self-driving vending machine to a control center; and

obtaining the replenishment station returned by the control center which is determined according to the location of the self-driving vending machine.

According to an embodiment of the present disclosure, the replenishment station may include:

a replenishment station nearest to the self-driving vending machine; or

a replenishment station that has the shortest travel time from the self-driving vending machine.

According to an embodiment, a replenishment apparatus for a self-driving vending machine is proposed, the replenishment apparatus includes:

an obtaining unit for obtaining information about remaining goods in the self-driving vending machine; and

an executing unit for controlling the self-driving vending machine to drive automatically to a replenishment station for replenishment when the executing unit determines according to the information about remaining goods that replenishment needs to be performed.

According to an embodiment of the present disclosure, the obtaining unit obtains the remaining quantity of goods; and

if the executing unit determines that the remaining quantity of goods is lower than a preset threshold, the executing unit determines that replenishment needs to be performed, and controls the self-driving vending machine to drive automatically to the replenishment station for replenishment.

According to an embodiment of the present disclosure, the obtaining unit obtains the remaining quantity of goods reported by a vending system in the self-driving vending machine periodically; or

the obtaining unit obtains the remaining quantity of goods reported by the vending system when the remaining quantity of goods is changed; or

the obtaining unit obtains the remaining quantity of goods reported by the vending system when the remaining quantity of goods is lower than the threshold.

According to an embodiment of the present disclosure, if the obtaining unit obtains the remaining quantity of goods reported by the vending system periodically, or obtains the remaining quantity of goods reported by the vending system when the remaining quantity of goods is changed, the executing unit compares the remaining quantity of goods obtained each time with the threshold, and determines that replenishment needs to be performed when the remaining quantity of goods is lower than the threshold; and

if the obtaining unit obtains the remaining quantity of goods reported by the vending system when the remaining quantity of goods is lower than the threshold, the executing unit determines that replenishment needs to be performed after obtaining the remaining quantity of goods.

According to an embodiment of the present disclosure, before controlling the self-driving vending machine to drive automatically to the replenishment station for replenishment, the executing unit determines the replenishment station according to a location of the self-driving vending machine, or reports the location of the self-driving vending machine to a control center and obtains the replenishment station returned by the control center which is determined according to the location of the self-driving vending machine.

According to an embodiment of the present disclosure, the replenishment station may include:

a replenishment station nearest to the self-driving vending machine; or

a replenishment station that has the shortest travel time from the self-driving vending machine.

According to an embodiment, it is proposed a computer device, including a memory, a processor and a computer program which is stored on the memory and runs on the processor, the processor, upon executing the program, implementing the above-mentioned method.

According to an embodiment, it is proposed a computer-readable storage medium on which a computer program is stored, the program, when executed by the processor, implementing the aforesaid method.

As may be seen from the above introduction, according to the technical solutions of the present disclosure, the self-driving system in the self-driving vending machine may obtain information about remaining goods, and may control the self-driving vending machine to drive automatically to a replenishment station for replenishment when it is determined according to the information about remaining goods that replenishment needs to be performed, thereby implementing timely replenishment for the self-driving vending machine and ensuring normal work of the self-driving vending machine.

### BRIEF DESCRIPTION OF THE DRAWINGS

FIG. 1 is a flow chart of a replenishment method for a self-driving vending machine according to a first embodiment of the present disclosure.

FIG. 2 is a flow chart of a replenishment method for a self-driving vending machine according to a second embodiment of the present disclosure.

FIG. 3 is a flow chart of a replenishment method for a self-driving vending machine according to a third embodiment of the present disclosure.

FIG. 4 is a structural schematic diagram of components for a replenishment apparatus of a self-driving vending machine according to an embodiment of the present disclosure.

FIG. 5 illustrates a block diagram of an example computer system/server 12 adapted to implement an implementation mode of the present disclosure.

### DETAILED DESCRIPTION

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

In addition, it should be appreciated that the term “and/or” used in the text is only an association relationship depicting associated objects and indicates that three relations might exist, for example, A and/or B may represent three cases, namely, A exists individually, both A and B coexist, and B exists individually. In addition, the symbol “/” in the text generally indicates associated objects before and after the symbol are in an “or” relationship.

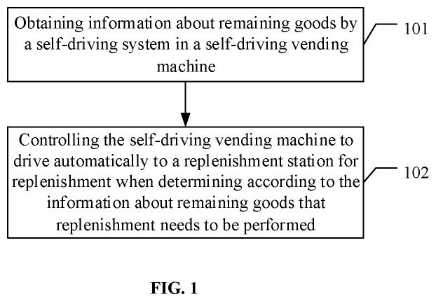

FIG. 1 is a flow chart of a replenishment method for a self-driving vending machine according to a first embodiment of the present disclosure. As shown in FIG. 1, the embodiment includes the following.

At 101, a self-driving system in the self-driving vending machine obtains information about remaining goods.

At 102, if it is determined according to the information about remaining goods that replenishment needs to be performed, the self-driving vending machine is controlled to drive automatically to a replenishment station for replenishment.

In this embodiment, the self-driving system in the self-driving vending machine may communicate with a vending system, and the self-driving system may obtain the information about the remaining goods.

Preferably, the remaining quantity of goods may be obtained.

In addition, the self-driving system may obtain periodically the remaining quantity of goods reported by the vending system in the self-driving vending machine, or obtain the remaining quantity of goods reported by the vending system when the remaining quantity of goods is changed, or obtain the remaining quantity of goods reported by the vending system when the remaining quantity of goods is lower than a preset threshold.

The vending system may detect periodically the remaining quantity of goods for sales, and may report each detection result to the self-driving system, or, report the number of current remaining goods to the self-driving system whenever the remaining quantity of goods is changed, i.e., whenever the goods is sold, or report the number of current remaining goods to the self-driving system only when the remaining quantity of goods is lower than a preset threshold. Which manner employed may be determined according to practical requirement. The value of the threshold may be determined according to practical requirement.

After the self-driving system obtains the remaining quantity of goods, if the self-driving system determines that the remaining quantity of goods is lower than the preset threshold, it may be determined that replenishment needs to be performed.

After determining that replenishment needs to be performed, the self-driving system may further determine a replenishment station.

For example, the self-driving system may determine the replenishment station according to a location of the self-driving vending machine, or the self-driving system may report the location of the self-driving vending machine to a control center and obtain the replenishment station returned by the control center which is determined according to the location of the self-driving vending machine.

The determined replenishment station may be a replenishment station nearest to the self-driving vending machine, or a replenishment station that has the shortest travel time from the self-driving vending machine.

The self-driving system may determine the replenishment station nearest to the self-driving vending machine or the replenishment station that has the shortest travel time from the self-driving vending machine according to pre-stored location information of replenishment stations, or according to location information of replenishment stations found by searching, in conjunction with the location of the self-driving vending machine, and by means of processing such as path searching and path planning. The control center may determine the replenishment station in a similar manner after obtaining the location of the self-driving vending machine reported by the self-driving system.

After determining the replenishment station, the self-driving system may control the self-driving vending machine to drive automatically to the replenishment station for replenishment.

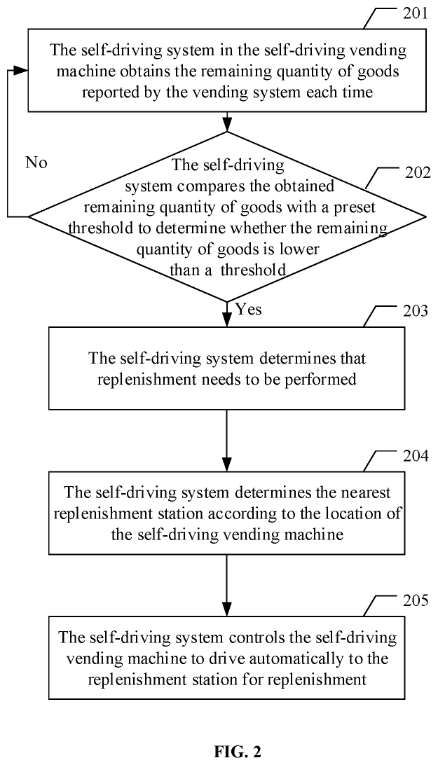

Based on the above description, FIG. 2 is a flow chart of a replenishment method of a self-driving vending machine according to a second embodiment of the present disclosure. As shown in FIG. 2, the following is included.

At 201, the self-driving system in the self-driving vending machine obtains the remaining quantity of goods reported by the vending system each time.

The self-driving system may obtain periodically the remaining quantity of goods reported by the vending system, or obtain the remaining quantity of goods reported by the vending system when the remaining quantity of goods is changed, or obtain the remaining quantity of goods reported by the vending system when the remaining quantity of goods is lower than a preset threshold. One of the first two manners is employed in the present embodiment.

At 202, the self-driving system compares the obtained remaining quantity of goods with a preset threshold to determine whether the remaining quantity of goods is lower than the threshold, and if yes, executes 203, otherwise repeats 201.

At 203, the self-driving system determines that replenishment needs to be performed.

If the remaining quantity of goods reported by the vending system is obtained periodically, or the remaining quantity of goods reported by the vending system when the remaining quantity of goods is changed, the self-driving system may compare the remaining quantity of goods obtained each time with the threshold, and determine that replenishment needs to be performed if the remaining quantity of goods is lower than the threshold, otherwise continue to obtain the remaining quantity of goods reported next time, and then compare the number with the threshold.

At 204, the self-driving system determines the nearest replenishment station according to the location of the self-driving vending machine.

Optionally, the self-driving system may determine the replenishment station that has the shortest travel time from the self-driving vending machine according to the location of the self-driving vending machine. Optionally, the self-driving system may report the location of the self-driving vending machine to a control center and obtain the replenishment station returned by the control center which is determined according to the location of the self-driving vending machine, where the replenishment station determined by the control center may be a replenishment station nearest to the self-driving vending machine, or a replenishment station that has the shortest travel time from the self-driving vending machine.

At 205, the self-driving system controls the self-driving vending machine to drive automatically to the replenishment station for replenishment.

How to control the self-driving vending machine to drive automatically to the replenishment station is already known. After the self-driving vending machine reaches the replenishment station, the staff of the replenishment station may manually replenish the goods, and the self-driving vending machine continues to sell goods after the replenishment is completed.

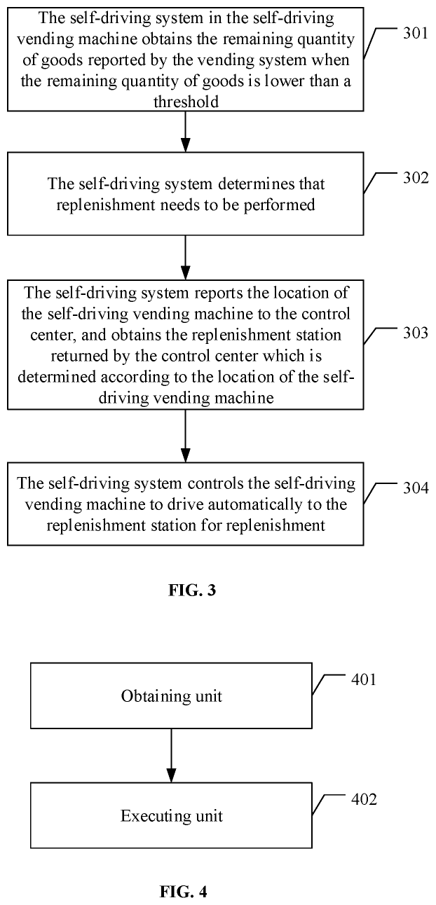

FIG. 3 is a flow chart of a replenishment method of a self-driving vending machine according to a third embodiment of the present disclosure. As shown in FIG. 3, the following is included.

At 301, the self-driving system in the self-driving vending machine obtains the remaining quantity of goods reported by the vending system when the remaining quantity of goods is lower than a threshold.

The self-driving system may obtain periodically the remaining quantity of goods reported by the vending system, or obtain the remaining quantity of goods reported by the vending system when the remaining quantity of goods is changed, or obtain the remaining quantity of goods reported by the vending system when the remaining quantity of goods is lower than a preset threshold. The last manner of the foregoing manners is employed in the present embodiment.

At 302, the self-driving system determines that replenishment needs to be performed.

If the remaining quantity of goods reported by the vending system when the remaining quantity of goods is lower than the threshold is obtained, after obtaining the reported remaining quantity of goods, the self-driving system may determine that the remaining quantity of goods is lower than the threshold, thereby determining that replenishment needs to be performed.

At 303, the self-driving system reports the location of the self-driving vending machine to the control center, and obtains the replenishment station returned by the control center which is determined according to the location of the self-driving vending machine.

The replenishment station determined by the control center may be a replenishment station nearest to the self-driving vending machine, or a replenishment station that has the shortest travel time from the self-driving vending machine.

The self-driving system may determine the replenishment station nearest to the self-driving vending machine, or, may determine the replenishment station that has the shortest travel time from the self-driving vending machine according to location of the self-driving vending machine.

At 304, the self-driving system controls the self-driving vending machine to drive automatically to the replenishment station for replenishment.

How to control the self-driving vending machine to drive automatically to the replenishment station is already known. After the self-driving vending machine reaches the replenishment station, the staff of the replenishment station may manually replenish the goods, and the self-driving vending machine continues to sell goods after the replenishment is completed.

As appreciated, for ease of description, the aforesaid method embodiments are all described as a combination of a series of actions, but those skilled in the art should appreciated that the present disclosure is not limited to the described order of actions because some steps may be performed in other orders or simultaneously according to the present disclosure. Secondly, those skilled in the art should appreciate the embodiments described in the description all belong to preferred embodiments, and the involved actions and modules are not necessarily requisite for the present disclosure.

In the above embodiments, embodiments are respectively described with respective focuses, and reference may be made to related depictions in other embodiments for portions not detailed in a certain embodiment.

In summary, according to the technical solutions of the method embodiments of the present disclosure, the self-driving system in the self-driving vending machine may obtain information about remaining goods such as the remaining quantity of goods, and may control the self-driving vending machine to drive automatically to a replenishment station for replenishment if it is determined according to the information about remaining goods that replenishment needs to be performed, thereby implementing timely replenishment for the self-driving vending machine and ensuring normal work of the self-driving vending machine.

The above introduces the method embodiments. The technical solution of the present disclosure will be further described through an apparatus embodiment.

FIG. 4 is a structural schematic diagram of components of an embodiment of a replenishment apparatus of a self-driving vending machine according to the present disclosure. As shown in FIG. 4, the apparatus includes an obtaining unit 401 and an executing unit 402.

The obtaining unit 401 is configured to obtain information about remaining goods in the self-driving vending machine.

The executing unit 402 is configured to control the self-driving vending machine to drive automatically to a replenishment station for replenishment if the executing unit determines according to the information about remaining goods that replenishment needs to be performed.

Preferably, the obtaining unit 401 may obtain the remaining quantity of goods.

In addition, the obtaining unit 401 may obtains periodically the remaining quantity of goods reported by the vending system in the self-driving vending machine, or obtain the remaining quantity of goods reported by the vending system when the remaining quantity of goods is changed, or obtain the remaining quantity of goods reported by the vending system when the remaining quantity of goods is lower than a preset threshold.

After the executing unit 402 obtains the remaining quantity of goods, if the executing unit 402 determines that the remaining quantity of goods is lower than the preset threshold, it may determine that replenishment needs to be performed.

Specifically, if the obtaining unit 401 obtains periodically the remaining quantity of goods reported by the vending system or obtain the remaining quantity of goods reported by the vending system when the remaining quantity of goods is changed, the executing unit 402 may compare the remaining quantity of goods obtained each time with the threshold, and determine that replenishment needs to be performed if the remaining quantity of goods is lower than the threshold. If the obtaining unit 401 obtains the remaining quantity of goods reported by the vending system when the remaining quantity of goods is lower than the threshold, the executing unit 402 may determine that replenishment needs to be performed after obtaining the remaining quantity of goods.

After determining that replenishment needs to be performed, the executing unit 402 may further determine a replenishment station.

For example, it is possible to determine the replenishment station according to a location of the self-driving vending machine, or report the location of the self-driving vending machine to a control center and obtain the replenishment station returned by the control center and determined according to the location of the self-driving vending machine.

The determined replenishment station may include: a replenishment station nearest to the self-driving vending machine, or a replenishment station that has the shortest travel time from the self-driving vending machine.

After determining the replenishment station, the executing unit 402 may control the self-driving vending machine to drive automatically to the replenishment station for replenishment.

Reference may be made to relevant depictions in the above method embodiments for a specific workflow of the above apparatus embodiment shown in FIG. 4, which will not be detailed any more here.

To sum up, the technical solution of the apparatus embodiment of the present disclosure may be employed to implement timely replenishment for the self-driving vending machine and ensure normal work of the self-driving vending machine.

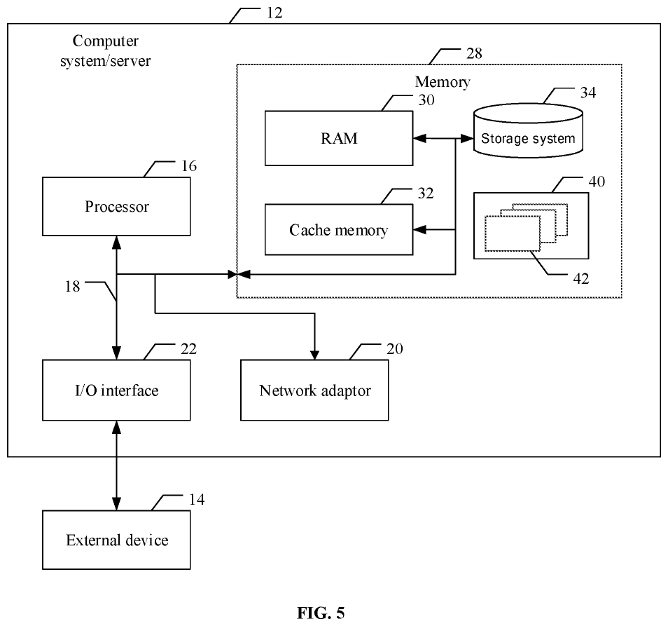

FIG. 5 illustrates a block diagram of an example computer system/server 12 adapted to implement an implementation mode of the present disclosure. The computer system/server 12 shown in FIG. 5 is only an example and should not bring about any limitation to the function and scope of use of the embodiments of the present disclosure.

As shown in FIG. 5, the computer system/server 12 is shown in the form of a general-purpose computing device. The components of computer system/server 12 may include, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

Memory 28 may include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 may be provided for reading from and writing to a non-removable, non-volatile magnetic media (not shown in FIG. 5 and typically called a “hard drive”). Although not shown in FIG. 5, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media may be provided. In such instances, each drive may be connected to bus 18 by one or more data media interfaces. The memory 28 may include at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might include an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication may occur via Input/Output (I/O) interfaces 22. Still yet, computer system/server 12 may communicate with one or more networks such as a local area network (LAN), a general wide area network (WAN), and/or a public network (e.g., the Internet) via network adapter 20. As depicted in FIG. 5, network adapter 20 communicates with the other communication modules of computer system/server 12 via bus 18. It should be understood that although not shown, other hardware and/or software modules could be used in conjunction with computer system/server 12. Examples, include, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1, FIG. 2 or FIG. 3.

The present disclosure meanwhile provides a computer-readable storage medium on which a computer program is stored, the program, when executed by the processor, implementing the method stated in the embodiment shown in FIG. 1, FIG. 2 or FIG. 3.

The computer-readable medium of the present embodiment may employ any combinations of one or more computer-readable media. The machine readable medium may be a machine readable signal medium or a machine readable storage medium. A machine readable medium may include, but not limited to, an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium may be any tangible medium that include or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages include an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method may be implemented in other ways. For example, the above-described embodiments for the apparatus are only exemplary, e.g., the division of the units is merely logical one, and, in reality, they may be divided in other ways upon implementation.

The units described as separate parts may be or may not be physically separated, the parts shown as units may be or may not be physical units, i.e., they may be located in one place, or distributed in a plurality of network units. One may select some or all the units to achieve the purpose of the embodiment according to the actual needs.

Further, in the embodiments of the present disclosure, functional units may be integrated in one processing unit, or they may be separate physical presences; or two or more units may be integrated in one unit. The integrated unit described above may be implemented in the form of hardware, or they may be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium includes various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A replenishment method for a self-driving vending machine, comprising:
obtaining information about remaining goods by a self-driving system in the self-driving vending machine;
controlling the self-driving vending machine to drive automatically to a replenishment station for replenishment, when determining, according to the information about remaining goods, that replenishment needs to be performed.

2. The replenishment method according to claim 1, wherein the obtaining information about remaining goods comprises:
obtaining a remaining quantity of goods, and
wherein controlling the self-driving vending machine to drive automatically to a replenishment station for replenishment, when determining, according to the information about remaining goods, that replenishment needs to be performed, comprises:
determining that replenishment needs to be performed when the remaining quantity of goods is lower than a threshold and controlling the self-driving vending machine to drive automatically to the replenishment station for replenishment.

3. The replenishment method according to claim 2, wherein the obtaining the remaining quantity of goods comprises at least one of the following steps:
obtaining the remaining quantity of goods reported by a vending system in the self-driving vending machine periodically;
obtaining the remaining quantity of goods reported by the vending system when the remaining quantity of goods is changed; or
obtaining the remaining quantity of goods reported by the vending system when the remaining quantity of goods is lower than the threshold.

4. The replenishment method according to claim 3, wherein the determining that replenishment needs to be performed when the remaining quantity of goods is lower than a threshold comprises:
under the condition of at least one of: obtaining the remaining quantity of goods reported by the vending system periodically, or obtaining the remaining quantity of goods reported by the vending system when the remaining quantity of goods is changed,
comparing the remaining quantity of goods obtained each time with the threshold, and determining that replenishment needs to be performed when the remaining quantity of goods is lower than the threshold;
under the condition of obtaining the remaining quantity of goods reported by the vending system when the remaining quantity of goods is lower than the threshold,
determining that replenishment needs to be performed after obtaining the remaining quantity of goods.

5. The replenishment method according to claim 1, wherein before controlling the self-driving vending machine to drive automatically to the replenishment station for replenishment, the method further comprises:
determining the replenishment station according to a location of the self-driving vending machine.

6. The replenishment method according to claim 5, wherein the determining the replenishment station according to a location of the self-driving vending machine comprises:
reporting the location of the self-driving vending machine to a control center;
obtaining the replenishment station returned by the control center which is determined according to the location of the self-driving vending machine.

7. The replenishment method according to claim 5, wherein the replenishment station comprises at least one of:
a replenishment station nearest to the self-driving vending machine; or
a replenishment station that has the shortest travel time from the self-driving vending machine.

8. A computer device, comprising a memory, a processor and a computer program which is stored on the memory and runs on the processor, wherein the processor, upon executing the program, implements a replenishment method for a self-driving vending machine, wherein the replenishment method comprises:
obtaining information about remaining goods by a self-driving system in the self-driving vending machine;
controlling the self-driving vending machine to drive automatically to a replenishment station for replenishment, when determining, according to the information about remaining goods, that replenishment needs to be performed.

9. The computer device according to claim 8, wherein the obtaining information about remaining goods comprises:
obtaining a remaining quantity of goods, and
wherein controlling the self-driving vending machine to drive automatically to a replenishment station for replenishment, when determining, according to the information about remaining goods, that replenishment needs to be performed, comprises:
determining that replenishment needs to be performed when the remaining quantity of goods is lower than a threshold and controlling the self-driving vending machine to drive automatically to the replenishment station for replenishment.

10. The computer device according to claim 9, wherein the obtaining the remaining quantity of goods comprises at least one of the following steps:
obtaining the remaining quantity of goods reported by a vending system in the self-driving vending machine periodically;
obtaining the remaining quantity of goods reported by the vending system when the remaining quantity of goods is changed; or
obtaining the remaining quantity of goods reported by the vending system when the remaining quantity of goods is lower than the threshold.

11. The computer device according to claim 10, wherein the determining that replenishment needs to be performed when the remaining quantity of goods is lower than a threshold comprises:
under the condition of at least one of: obtaining the remaining quantity of goods reported by the vending system periodically, or obtaining the remaining quantity of goods reported by the vending system when the remaining quantity of goods is changed,
comparing the remaining quantity of goods obtained each time with the threshold, and determining that replenishment needs to be performed when the remaining quantity of goods is lower than the threshold;
under the condition of obtaining the remaining quantity of goods reported by the vending system when the remaining quantity of goods is lower than the threshold,
determining that replenishment needs to be performed after obtaining the remaining quantity of goods.

12. The computer device according to claim 8, wherein before controlling the self-driving vending machine to drive automatically to the replenishment station for replenishment, the method further comprises:
determining the replenishment station according to a location of the self-driving vending machine.

13. The computer device according to claim 12, wherein the determining the replenishment station according to a location of the self-driving vending machine comprises:
reporting the location of the self-driving vending machine to a control center;
obtaining the replenishment station returned by the control center which is determined according to the location of the self-driving vending machine.

14. The computer device according to claim 12, wherein the replenishment station comprises at least one of:
a replenishment station nearest to the self-driving vending machine; or
a replenishment station that has the shortest travel time from the self-driving vending machine.

15. A non-transitory computer-readable storage medium on which a computer program is stored, wherein the program, when executed by a processor, implements a replenishment method for a self-driving vending machine, wherein the replenishment method comprises:
obtaining information about remaining goods by a self-driving system in the self-driving vending machine;
controlling the self-driving vending machine to drive automatically to a replenishment station for replenishment, when determining, according to the information about remaining goods, that replenishment needs to be performed.

16. The non-transitory computer-readable storage medium according to claim 15, wherein the obtaining information about remaining goods comprises:
obtaining a remaining quantity of goods, and
wherein controlling the self-driving vending machine to drive automatically to a replenishment station for replenishment, when determining, according to the information about remaining goods, that replenishment needs to be performed, comprises:
determining that replenishment needs to be performed when the remaining quantity of goods is lower than a threshold and controlling the self-driving vending machine to drive automatically to the replenishment station for replenishment.

17. The non-transitory computer-readable storage medium according to claim 16, wherein the obtaining the remaining quantity of goods comprises at least one of the following steps:
obtaining the remaining quantity of goods reported by a vending system in the self-driving vending machine periodically;
obtaining the remaining quantity of goods reported by the vending system when the remaining quantity of goods is changed; or
obtaining the remaining quantity of goods reported by the vending system when the remaining quantity of goods is lower than the threshold.

18. The non-transitory computer-readable storage medium according to claim 17, wherein the determining that replenishment needs to be performed when the remaining quantity of goods is lower than a threshold comprises:
under the condition of at least one of: obtaining the remaining quantity of goods reported by the vending system periodically, or obtaining the remaining quantity of goods reported by the vending system when the remaining quantity of goods is changed,
comparing the remaining quantity of goods obtained each time with the threshold, and determining that replenishment needs to be performed when the remaining quantity of goods is lower than the threshold;
under the condition of obtaining the remaining quantity of goods reported by the vending system when the remaining quantity of goods is lower than the threshold,
determining that replenishment needs to be performed after obtaining the remaining quantity of goods.

19. The non-transitory computer-readable storage medium according to claim 15, wherein before controlling the self-driving vending machine to drive automatically to the replenishment station for replenishment, the method further comprises:
determining the replenishment station according to a location of the self-driving vending machine.

20. The non-transitory computer-readable storage medium according to claim 19, wherein the determining the replenishment station according to a location of the self-driving vending machine comprises:
reporting the location of the self-driving vending machine to a control center;
obtaining the replenishment station returned by the control center which is determined according to the location of the self-driving vending machine.
